(19) United States
(12) Patent Application Publication
(10) Pub. No.: US 2003/0208347 A1
(43) Pub. Date: Nov. 6, 2003

(54) Accurate junction capacitance model for high-speed circuit simulator

(75) Inventor: Andy Huang, San Jose, CA (US)

Correspondence Address: ANDY HUANG, 2880 ZANKER ROAD, SUITE 203, SAN JOSE, CA, 95134, US

(73) Assignee: Mr. Andy Huang, ACAD, Corp., San Jose, CA

(21) Appl. No.: 10/063,626

(22) Filed: May 3, 2002

(51) Int. Cl. G06F 17/50

(52) U.S. Cl. 703/14

(57) ABSTRACT

A method for modeling junction capacitance of the MOSFET transistor is proposed and implemented for high-speed circuit simulator. A region-based value of the capacitance of MOSFET is proposed, and its regional capacitance value model is more accurate and takes less computation time than the conventional bias independent average capacitance model.

### CROSS REFERENCE TO RELATED APPLICATIONS

U.S. Pat. No. 5,384,710 January, 1995 Lam et al. 364/489.

### BACKGROUND OF INVENTION

In verifying the VLSI, especially in the circuit level, the speed and accuracy are the biggest research topics to tackle the complex and huge design, usually over tens of millions of transistors. There have been lots of researches to complete the design verification to meet the time-to-market, but the basic concept was that there are trade-off between speed and accuracy. In addition to the relation between them, the circuit level, verifying the VLSI at the transistor level, is facing the biggest difficulties among the levels of the design methodology, because the size of the transistors becomes too big to simulate in a day or in a week. To keep the simulation at the circuit level in a day or a week, a method of modeling of the MOSFET and an analysis technique to be applied at the circuit simulator are proposed. To overcome the conventional transistor level simulation, lots of techniques were devised. The table-lookup technique, which replaced the method of finding the value of characteristics of the transistor from time-consuming mathematic procedure, was popular because of its performance. The table look-up performs the simulation by searching the table that has all the characteristics of the transistor—such as temperature, current between drain and source of the transistor, Vgs, Vds, and the relation between them, etc. Among the characteristics, intrinsic capacitance of the MOSFET has the greatest effects on the high speed circuit simulator. Basically and conventionally, the value of the intrinsic capacitance is modeled as the value with the average, but it can have big error impact on the circuit simulation because this technique cannot consider the variance of the capacitance depends on the Vsb or Vdb. To get more accurate simulation, division of the characteristic of the junction capacitance with value of the Vsb is proposed. Based on the value of Vsb, we divide small and large Vsb region, each region was represented by its region average value. By dividing it with regions, the value can have the bias dependant; the simulation with this idea can have accuracy as well as performance.

### BRIEF DESCRIPTION OF DRAWINGS

FIG. 1 is a simulation flow using lookup table modeling.

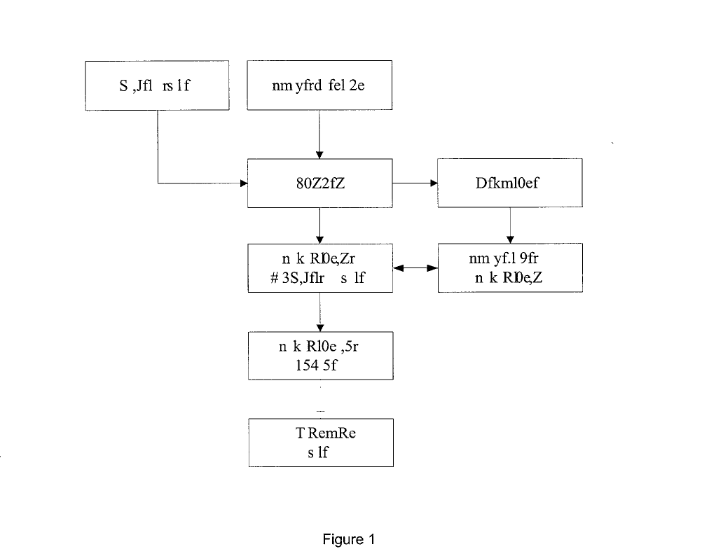

FIG. 2 is a modeling junction capacitance of MOSFET

FIG. 3 is the value of capacitance Cj1 at the small Vsb region, and The corresponding value at the large region is Cj2, and, which are modeled as Cj1, Cj2

### DETAILED DESCRIPTION

Procedure to Generate Lookup Table of the MOSFET

By parsing the input net-list, each of the transistors in the circuit was classified depends on the width and length of the transistors for spice-like simulator. Another words, the transistors were gathered depend on their size and template-set were built for the target simulator. With the template-set, the circuit simulator generates the lookup table, which the components of the tables are characteristics of the each transistors of the circuit. Template-set consists of template 1 and template 2. Template 1 has components to model the threshold voltage and the value of junction capacitance, while the template 2 has components to model the drain-source current and value of the gate capacitance of the transistor. The template in the Table 1 and 2 are the example for the HSPICE, the circuit simulator

Table 1. Sample Template of HSPICE for a NMOS

Vsb 1 0

M0 1 1 1 0

.dc vsb start=min_vsb stop=max_vsb step=vsb_step

.print Iv9(m0) Ix28(m0) Ix29(m0)

Table 2. Sample Template 2 of HSPICE for a NMOS

vds 1 0

vgs 2 0

m0 1 2 0 0

.dc vds start=minvds stop=maxvds step=step1 vgs

start=minvgs stop=maxvgs step=step2

.print dc Ix4(m0) Ix78(m0) Ix19(m0) Ix20(m0)

Piecewise Constant Junction Capacitance Modeling

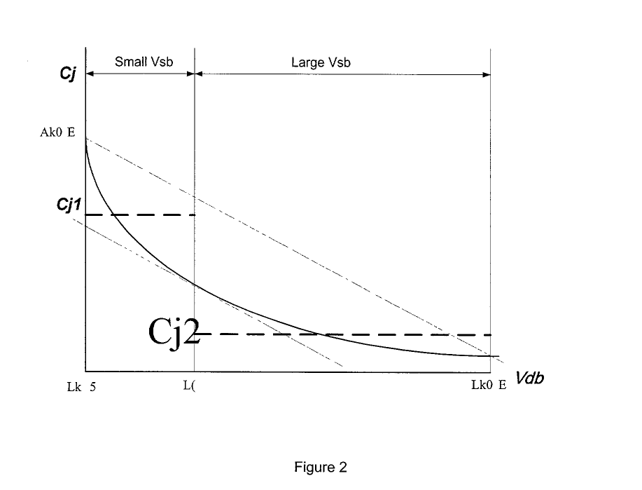

The value of the junction capacitance decreased monotonously as Vsb decreased, as shown at the FIG. 2. According to the value of V1, there can divide the range small and large Vsb region. For convenience, let us assume the value of V1 as half of the Vmax.

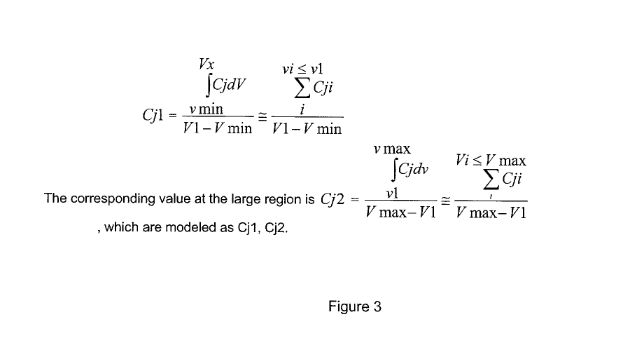

The value of capacitance Cj1 at the small Vsb region is as follows in FIG. 3

1. The method of modeling the junction capacitance of the MOSFET and a analysis technique of it for high-speed circuit simulator comprising that a) the way to input a net-list of the circuit to be simulated b) creation procedure to make template net-list as the input net-list for external simulator c) creation procedure to make a lookup table model for the MOSFET d) how to model the value of the junction capacitance of MOSFET as piecewise constant
